(19) United States
(12) Patent Application Publication
(10) Pub. No.: US 2009/0101220 A1
(43) Pub. Date: Apr. 23, 2009

(54) Removable auxiliary area fuel tank for motorcycles

(76) Inventor: Delbert William Mundy, Phoenix, AZ (US)

Correspondence Address: Cahill, von Hellens & Glazer P.L.C., 155 Park One, 2141 E.Highland Avenue, Phoenix, AZ, 85016, US

(21) Appl. No.: 11/975,839

(22) Filed: Oct. 22, 2007

(51) Int. Cl. B62J 35/00

(52) U.S. Cl. 137/575; 220/288; 220/562; 280/834

(57) ABSTRACT

An auxiliary fuel tank mounts on top of a primary fuel tank to provide additional fuel capacity. The auxiliary fuel tank and primary fuel tank establish a single fuel volume. The auxiliary fuel tank contains interconnecting means to replace the primary tank gas cap, support auxiliary fuel tank, and can detachably attach the auxiliary tank to the primary tank at the fill point of the primary tank. The bottom of the auxiliary fuel tank is equipped with a cap replacement for the primary tank and interconnects to form a seal. The interconnection includes an inlet tube that protrudes in and through the primary tank fill point to provide for the flow of gasoline and including ear members to prevent liquid from passing back into the auxiliary fuel tank. The auxiliary fuel tank includes a separate fill point to allow for fueling of the system once attached. The auxiliary fuel tank can be shaped complementary to the primary tank outer surface and may be fastened to the primary tank or motorcycle frame. The invention also provides a method of providing additional fuel capacity with an auxiliary fuel tank and attaching it to the primary tank directly to the primary tank fill point.

### BACKGROUND OF THE INVENTION

1. Field of the Invention

The present invention relates to auxiliary fuel tanks and, more particularly, to detachably attachable auxiliary fuel tanks for motorcycles and all-terrain vehicles.

2. Description of the Related Art

The motorcycle, having two separate axles or independent axles supporting two, three or four wheels, or motor bike, is a land-based motor vehicle powered by an engine, and commonly characterized by an open air driver space. The engines for modern motorcycles and all-terrain vehicles (ATVs) are fueled by gasoline. Many vehicle models locate a primary gasoline fuel tank in front of the driver's seat and behind the steering mechanism.

Although motorcycles tend to be more efficient than other vehicles, with a high miles-per-gallon of gasoline ratio, much of this efficiency is gained in the relatively small size, truss frame construction, and low weight of the vehicle itself. Thus, an engine will perform less work to travel a set distance. The total weight of the vehicle can be minimized to increase efficiency. During the development of motorcycles and ATVs, the frame and engine weight were engineered, and engine performance perfected, to maximize efficiency.

Fuel tanks on the modern motorcycle and ATV are situated below and in front of the driver within the frame of the vehicle. Given the positioning of the tanks and the relative size of the vehicle, common motorcycle tanks contain a capacity of approximately two (2) to four (4) gallons of gasoline.

With the advent of motorcycle racing, motocross races, endurance tests, and general recreation, the demand for greater fuel tank capacity has led to an array of various tank sizes and shapes. In addition, auxiliary fuel tanks have been inserted within the motorcycle frame, to increase the overall capacity of fuel.

An increase of as much as a single gallon of fuel (roughly a 25%-50% increase in total fuel capacity) can greatly improve the maintainable speed, time and distance in a race by either reducing the number of pit stops or increasing the distance a rider can ride within a set amount of time. In the arena of recreational riding and motocross, additional fuel can increase the useful riding time. As a means of transportation, additional fuel can greatly increase the distance that can be traveled before the need to refuel arises.

Others have attempted to increase the fuel capacity. One popular solution is to remove the original equipment manufacturer's primary fuel tank and install a larger primary fuel tank that encompasses most, if not all, of the space required for the original tank plus additional space. Many of these larger tanks encroach upon the driver's area. Enlarged primary tanks often jut above OEM tank height. Additional drawbacks to this solution include the expense of the larger tanks and the effort to install.

Another solution to increase the fuel capacity is through the installation of auxiliary fuel tanks within the frame of the vehicle, in or on the truss. The tanks are connected to the primary fuel tank via a system of hoses and/or tubing, or connected directly to a fuel delivery system, or connected directly to the engine carburetor.

Many methods have been implemented. U.S. Pat. No. 3,189,079 to Ferguson teaches a reserve fuel storage reservoir completely contained within the primary tank. U.S. Pat. No. 4,188,969 to Lotton et al. teaches a similar arrangement, placing a reserve fuel unit next to the primary tank, connecting the two reservoirs via a divider and fuel tube.

Others have increased fuel storage capacity by locating the reserve tanks elsewhere on the vehicle. These systems often connect to the primary tank by means of tubing and pumps. For instance, see U.S. Pat. No. 4,469,190, U.S. Pat. No. 4,653,762, U.S. Pat. No. 5,285,830. U.S. Pat. No. 3,754,569 to Fallotico teaches a way of appending a reserve tank to the primary tank at the inlet port, yet it uses a valve means to separate the reserve tank from the primary tank. Furthermore, Fallotico fails to teach methods of anchoring or attaching the reserve tank to the primary tank. As motorcycles tend to shift, angle and dive during turns and with the added torque and lateral forces experienced in the operation of these and other vehicles, the invention taught by Fallotico becomes impractical for motorcycles and ATVs, or any vehicle that operates to rotate about a horizontal axis to any significant degree. Fallotico also does not contemplate forces during operation of a vehicle as they effect the primary tank fill point positioned in close proximity to the turning mechanism. Fallotico also fails to provide a safe means of appending fuel capacity that protects a driver positioned in close proximity and without shielding to the auxiliary tank.

The present invention overcomes these practical considerations by increasing the support of the tank system interlock, adapting the shape and size of an auxiliary tank for motorcycles, providing support for the interconnection, providing a seal at the interconnection, and fuel fill at the auxiliary tank once attached to create single reservoir body without the need for any valve system.

Applying the reserve tank capacity within a motorcycle includes additional challenges due to the high ratio of engine volume to frame size. U.S. Pat. No. 4,577,719 to Nomura places the additional tank below the primary tank and U.S. Pat. No. 6,213,239 to Onishi places the reserve tank in a lateral space within the truss frame.

Although current solutions that increase fuel tank size or provide greater capacity overall fuel capacity, such solutions are often expensive and require total refit of the motorcycle to replace the primary tank or install an auxiliary fuel tank. Given recent advancements in materials and safety devices and the large growing interest in motocross, recreational motorbikers and hobbyists demand a lower cost and optional tank capacity item.

The conventional reserve tank systems fail to accommodate the needs of present day motorcyclists, racers, hobbyists, and recreationists by failing to provide an optional motorcycle auxiliary fuel tank that can be connected outside the frame of the vehicle. Such a solution will permit standard and extreme operation of the vehicle while maintaining safety.

It is therefore the primary object of the present invention to increase the total fuel capacity of a motor vehicle.

Another object of the present invention is to provide an auxiliary fuel tank having an interconnection with the fill inlet of a primary fuel tank that is readily removably installed in a motorcycle or ATV.

Still another object of the present invention is to provide an auxiliary fuel tank that can be detachably attached to a primary gas tank without need to augment the primary tank.

Yet another object of the present invention is to provide an auxiliary fuel tank that can be easily installed or attached and easily removed or disengaged from the gas inlet of a primary fuel tank.

A further object of the present invention is to provide a method for directly and detachably installing an auxiliary fuel tank upon the fixed fuel tank of a motorcycle to provide optional gasoline capacity.

A still further object of the present invention is provide a method for temporarily increasing the fuel capacity of a vehicle.

This and other objects of the present invention will become apparent to those skilled in the art as the description thereof proceeds

### SUMMARY OF THE INVENTION

The present invention relates to a complementary motorcycle auxiliary fuel tank that can be optionally installed and removed, in conjunction with a primary fuel tank. The auxiliary fuel tank interconnects with the primary fuel tank via the standard fuel inlet in the manner of a fuel cap. The auxiliary fuel tank is temporarily affixed to the top of the primary fuel tank at the fueling port, exterior to the vehicle frame, and can be easily installed and removed.

A motor vehicle auxiliary fuel tank is appended to a motor vehicle primary fuel tank to increase total vehicle fuel capacity. The auxiliary fuel tank is interconnected directly to the inlet port or fill point of the primary fuel tank. The auxiliary fuel tank is joined via detachable interlock with the primary fuel tank thus forming a single reservoir body for gasoline storage and use. The auxiliary fuel tank interconnection mimics the OEM cap interlock to provide for a gas tight seal replacement of the original gas cap. Once connected, the gas reservoir is one single space. The tank system may be filled from the top of the auxiliary fuel tank. The auxiliary fuel tank will be fitted with a vent hole in the auxiliary gas cap that is positioned on top of the auxiliary fuel tank and on top of the fuel tank system.

The auxiliary fuel tank has a main body shaped to compliment the primary fuel tank and a vehicle frame, potentially with overlapping side elements, so as to provide a mechanical fit, limit the amount of unused space and limit the danger that may be caused by a loose fitting or unsecured auxiliary fuel tank. Furthermore, fasteners may be mounted on the auxiliary fuel tank to help secure the auxiliary fuel tank to the OEM tank or vehicle body.

To ensure proper fill, transfer and flow of gasoline, the preferred embodiment of the auxiliary fuel tank includes a fuel inlet tube at the interconnection point that extends into the original OEM tank fuel reservoir. The fuel passes through the inlet tube and ear members are provided to prevent backwash into the auxiliary fuel tank as it is mounted above the OEM tank. Refueling may occur while the auxiliary fuel tank is attached to the OEM tank through an additional fuel inlet point on the auxiliary fuel tank located at top of the auxiliary tank and opposite the interconnection.

The invention also includes the method for providing additional fuel capacity to a vehicle. A temporary fuel tank may be affixed to the primary fuel tank and interconnected at the primary tank fuel inlet point, the auxiliary fuel tank is then mounted and fastened to the primary fuel tank and/or vehicle frame. The auxiliary fuel tank may be added at will to provide for additional fuel capacity or reverted to original fuel capacity without the auxiliary fuel tank engaged and removed at will.

### BRIEF DESCRIPTION OF THE DRAWINGS

The present invention will be described with greater specificity and clarity with reference to the following drawings, in which:

FIG. 1 is a lateral view of a motorcycle with a mounted auxiliary fuel tank;

FIG. 2 is a forward lateral view of an auxiliary fuel tank;

FIG. 3 illustrates the forward lateral view of an auxiliary fuel tank, as fitted complementary to an original equipment manufacturer primary tank;

FIG. 4 is a bottom view of an auxiliary fuel tank;

FIG. 5 illustrates an interlocking mechanism alternative in the female configuration;

FIG. 6 is a perspective view of the interlocking mechanism shown in FIG. 5;

FIG. 7 illustrates an interlocking mechanism alternative in the male configuration; and

FIG. 8 is a perspective view of the interlocking mechanism shown in FIG. 7.

### DESCRIPTION OF THE PREFERRED EMBODIMENT

An extended auxiliary fuel tank replaces the cap of a primary fuel tank. The auxiliary fuel tank can be attached at the fill point of a primary tank to create a seal. The volume of the auxiliary fuel tank is appended to the primary tank and serves to increase the total fuel capacity of the tank system. The auxiliary fuel tank has an independent fill point that performs the same function as the fill point of the primary tank. Thus, the auxiliary tank supplants the original gas cap, providing an extended version of the gas cap that contains added reservoir for fuel storage.

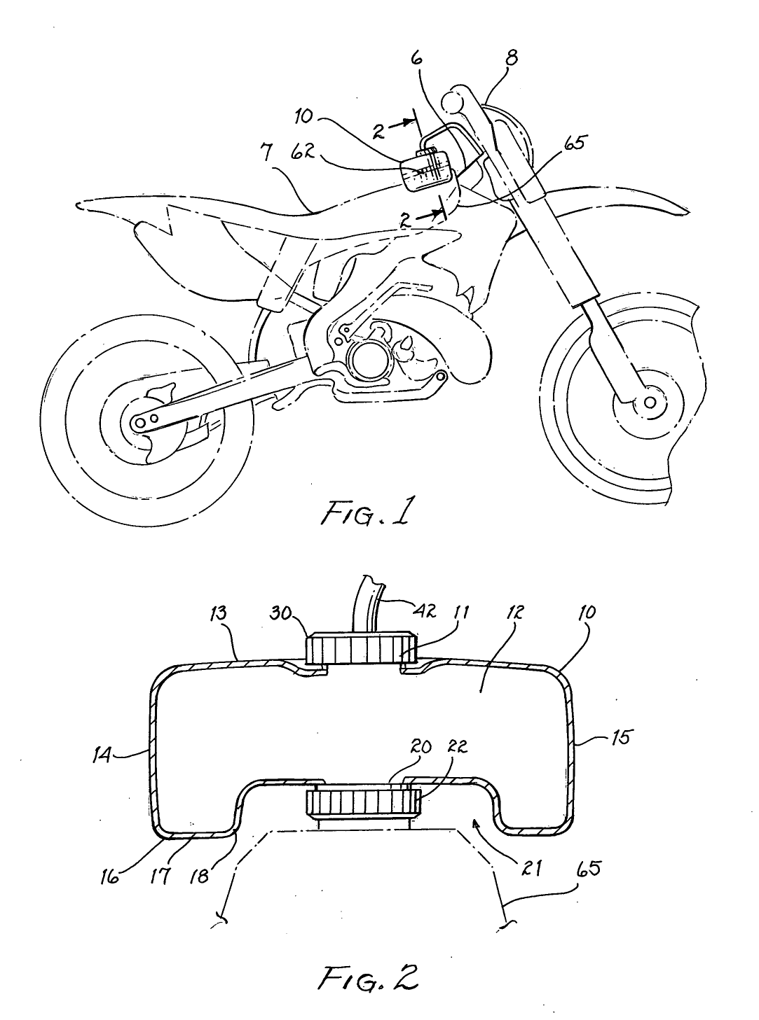

Referring to FIG. 1, there is illustrated a lateral view of the motorcycle with auxiliary fuel tank 10 mounted at fill point 62 of primary tank (also known as an original equipment manufactured tank or OEM tank) 65. The auxiliary fuel tank is positioned in front of seat 7 and behind steering mechanism 8 so as not to interfere with either. The auxiliary fuel tank extends upward from truss frame 6 and OEM tank 65 remains narrow in relation to the width of the truss frame.

Referring to FIG. 2, there is illustrated auxiliary fuel tank 10 with fuel engagement mechanism 11 allowing for fuel fill of auxiliary fuel tank body 12 having top surface 13, sides 14 and 15, and interfacing bottom surface 16 formed by horizontal interfacing planar surface 17 and angled interfacing planar surface 18.

Referring to both FIG. 2 and FIG. 3, at bottom surface 16 of the auxiliary fuel tank body 12, there is an outlet 20 for interconnection with an OEM tank 65. The interconnection is formed within indentation 21 surrounding the interconnection on three sides. Indentation 21 is sized to allow for manipulation of screw top mechanism 22 that acts as part of flange for threaded engagement with OEM tank 65. The interconnection may be in either male or female form, or any necessary configuration to complement OEM tank fill cap boss 61. The interconnection serves to form a seal with OEM tank 65 in place of a regular cap. Thus, the entry to fill OEM tank 65 is displaced by the auxiliary fuel tank.

Top surface 13 of auxiliary fuel tank 10 includes a fuel fill entry 40 with an engaging cap 30. Cap 30 may be twisted to open a seal and allow for fill of tank. Auxiliary fuel tank 10 will contain at least one vent 41 to allow for ambient pressure as liquid fuel is drawn into the primary tank and engine. In the preferred embodiment, vent 41 will be contained within and through cap 30 and connected to a draw-out tube 42 positioned to prevent fuel drip in an unsafe manner.

As illustrated in FIG. 3, auxiliary fuel tank 10 may be fitted, sized, shaped, or otherwise formed to complement the dimensions of OEM tank upper portion 60. For example, top surface 13 of OEM tank 65 may include horizontal surfaces 67 and angled surfaces 68. Auxiliary fuel tank 10 fits in a complementary manner over top 60 of the OEM tank and mounts to form a seal. Threaded engagement 23 interlocks with the complementary threaded boss 61 at primary tank fill point 62. When connected, OEM tank 65 and auxiliary fuel tank 10 form one complete tank structure 9 with single reservoir containing added capacity and additional surface area.

Auxiliary fuel tank 10 may contain additional features at outlet 5 that serve to facilitate fuel transfer from auxiliary fuel tank 10 to OEM tank 65 and inhibit fuel flow back into auxiliary fuel tank 10. In the preferred embodiment, inlet tube 2 serves to mount the auxiliary fuel tank 10 and house ear members 3 and draw hole 4. Inlet tube 2 may be of cylindrical shape, conical shape, or a ring housed entirely within outlet port 22. Ear members 3 can be either L-shaped bars, or curved L-shaped panels, in a circular pattern that border opening 5. Ear members may also form a completely circular bottom edge to inlet tube 2 with overlapping edges 3′. Draw hole 4 serves to provide pressure stabilization as fuel, gas and/or liquids flow between the auxiliary fuel tank and the OEM tank. It is the preferred characteristic of auxiliary fuel tank draw hole 4 to function to accept gasoline in gaseous form, or a gaseous mixture of air molecules, to stabilize the pressures as liquid gasoline flows into the OEM tank.

Gravity and inertia cause liquid gasoline to reach outlet 5 of auxiliary fuel tank 10. Initially, a fully-filled auxiliary fuel tank will have a liquid surface above fill point 62. As fuel in primary fuel tank 65 is depleted, the gasoline level in the tank system drops. The liquid gasoline in auxiliary fuel tank 10 must continue to make its way to outlet 5. The motion of acceleration, deceleration, lateral turning, and tilting of the vehicle will serve to transfer the liquid gasoline to the outlet 5. In the preferred embodiment, gravity will serve to move gasoline from auxiliary fuel tank outlet 5 through inlet tube 2 and into OEM tank 65. Inlet tube 2 serves to provide flow of liquid in one direction and inlet tube ear members 3 prevents back wash or upflow of liquid gasoline into auxiliary fuel tank 10. Other embodiments may include various other pumps and or one-way mechanisms to prevent back wash.

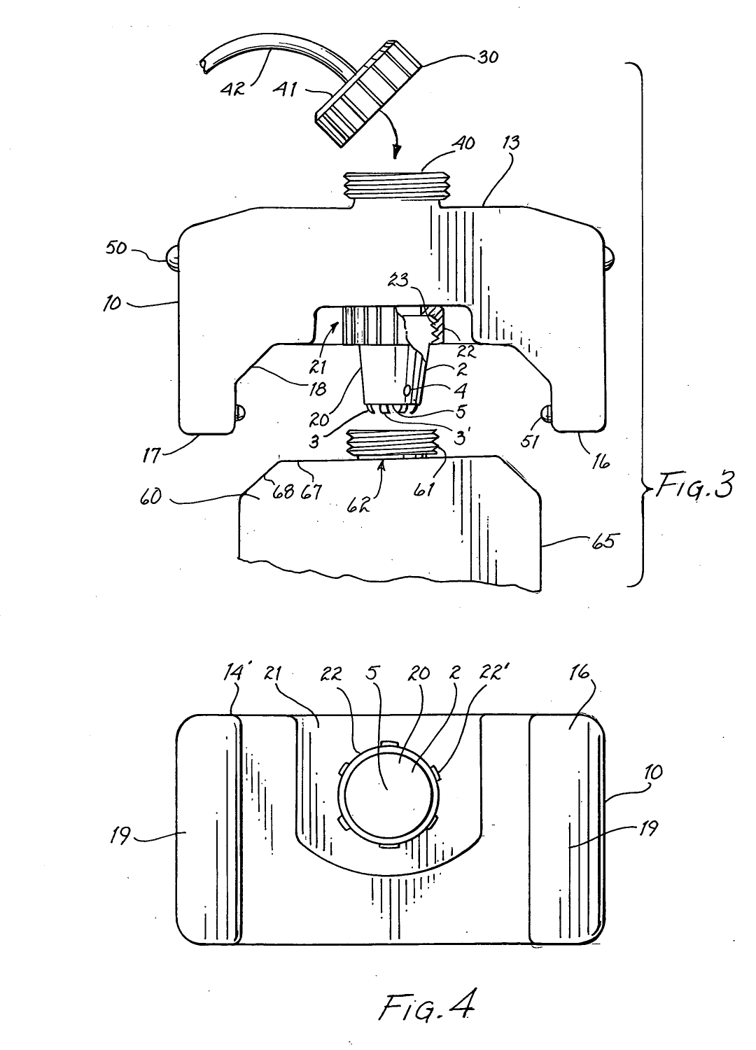

FIG. 4 demonstrates auxiliary fuel tank outlet 5 and outlet location 20 from a bottom view of auxiliary fuel tank 10. Auxiliary fuel tank 10 has bottom surface 16 reaching maxima 19 at both ends. Bottom surface 16 of auxiliary fuel tank 10 is contoured to compliment the top surface of the OEM tank to make a form fitting joint. Maxima 19 at both ends may reach generally below outlet 5. A fuel pump may be added to move the fuel from maxima 19 to the outlet 5 and through fuel inlet tube 2, or conversely the tank system may rely on the swinging and inclination of the vehicle during operation to force the fuel towards outlet 5.

Outlet 20 is designed to form a temporarily sealed interconnection with the OEM tank inlet. A recess indentation 21 is formed on bottom surface 16 surrounding the auxiliary fuel tank outlet 22, facing open to back side 14′. Indentation 21 is formed to allow for manipulation of cap 22′ to twist-on the interconnecting seal between the OEM tank and auxiliary fuel tank 10. The preferred method to interconnect the two tanks is with manual digital manipulation, however, many other modes are contemplated, such as strings, bars, sockets, wrenches or other tools to perform the necessary tightening of the seal.

Referring to FIG. 5, there is illustrated female interconnection apparatus 80 to join with a protruded male fill point on the primary fuel tank. Inlet tube 2 enters the primary tank at the fill point. Inlet tube 2 has an outflow region 81 that may have multiple pathways for liquid flow. Outflow region 81 is surrounded by and contained within ear members 3, which serve to prevent backwash of liquid fuel into the auxiliary fuel tank. A vent hole and path is provided at some point on interconnection apparatus 80, illustrated here on bottom 2′ of fill tube 2, to allow for gaseous fuel and air mixtures to flow back into and fill the auxiliary fuel tank. The air flow is necessary to provide and maintain stable pressure and facilitate liquid fuel flow.

Joined with, but independently swivelling, is an interconnection apparatus, generally a screw cap 22. The interconnection apparatus further contains inner side grooves 89 that interlock complementary with the outer screw means of the male primary tank fill point. Inner side grooves 89 engage the screw means and serve to connect the auxiliary fuel tank with the primary tank. Primary tank fill point screw threads abut the outer surface of the primary fuel tank and serve act as a hollow boss structure to support and engage with the auxiliary fuel tank. Outer edge 88 of outlet 22 contains a surface to interact with manipulation of auxiliary cap screw mechanism 80. Here outer edge 88 forms six bulges 88′ to allow for manual manipulation and twisting of interconnection element 80 to allow for engagement with primary tank fill point threads. This engagement can be tightened by hand, or with any practical tool.

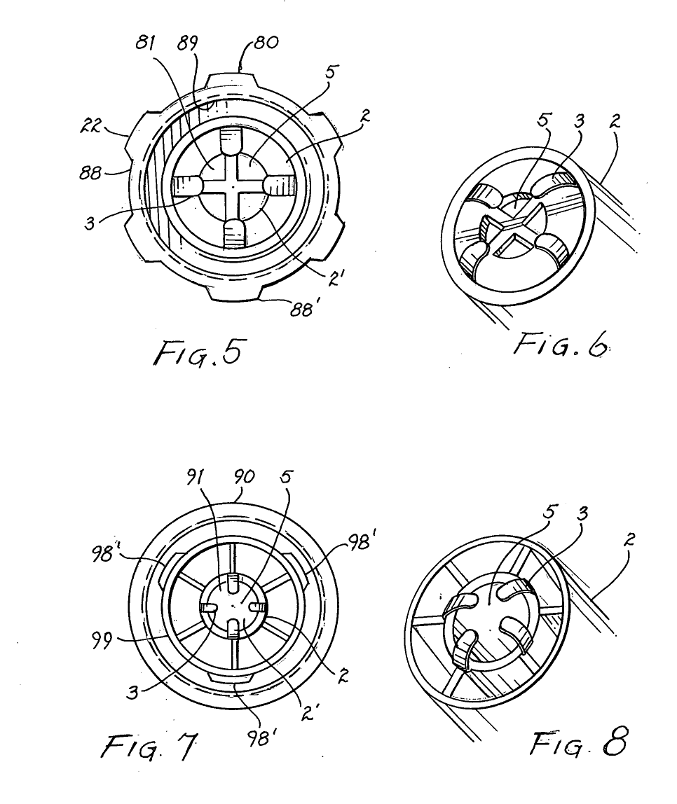

FIG. 6 illustrates a perspective view of the center of structure illustrated in FIG. 5. Ear members 3 extend beyond the flat surface of the bottom of inlet tube 2 and partially cover the fill hole to prevent backwash.

Referring to FIG. 7, there is illustrated the male interconnection apparatus 90 to join with a concave or female primary tank fill point. The outer edge 98 of the male interconnection engages the surface of the primary tank. Interlocking threads 98′ on the interior engaging edge 99 of the inlet tube 2 engage the threaded grooves present in the complementary primary tank fill point and any threaded interconnection means contained therein. The auxiliary fuel tank interconnection includes a outwardly extending boss that is inserted into the complementary fuel inlet of the OEM tank. The boss serves to support the auxiliary fuel tank and the threaded interconnection helps maintain the position of the auxiliary tank.

Outflow region 91 is surrounded by and contained within ear members 3, which serve to prevent backwash of liquid fuel into the auxiliary fuel tank. A vent hole and path is provided at some point on interconnection apparatus 90, illustrated here on bottom 2′ of fill tube 2, to allow for gaseous fuel and air mixtures to flow back into and fill the auxiliary fuel tank.

FIG. 8 illustrates a perspective view of the center of structure illustrated in FIG. 7. The ear members 3 extend beyond the flat surface of the bottom of the inlet tube 2 and partially cover the outlet 5 to prevent backwash.

As also shown in FIG. 3, auxiliary fuel tank 10 may be fastened to primary fuel tank 65 or the vehicle frame and components to improve stability and safety. Fasteners 51 may be mounted directly on the outer surface of the auxiliary fuel tank in the form of pins, snaps, welds, adhesives, buttons, clips, or any other fastening means that can be applied to complementary portion suitably affixed to motorcycle OEM tank, components or frame. Furthermore, fastening means may include straps, ties, clips, arms, bands, loops 50 or other fastening means that are not directly affixed to the auxiliary fuel tank, but may be run through loops or complementary features on the auxiliary fuel tank.

Should the user prefer to install pre-filled auxiliary fuel tanks, it is contemplated that a removable barrier may be applied to the inlet tube of the auxiliary fuel tank that can be removed remotely, or timed disintegration, once the auxiliary fuel tank is in place, either before or after the interconnection means is secured.

I claim:

1. A motor vehicle auxiliary fuel tank is comprising:
a main body;
said main body including a reservoir adapted for fuel storage;
interconnection means to attach said main body directly to an inlet port of a primary fuel tank of the motor vehicle;
said interconnection means including passageway for liquid and gas interchange;
said interconnection means including a draw hole;
a seal formed at the connecting point between said auxiliary fuel tank and the primary fuel tank;
a fuel fill point mounted on said auxiliary fuel tank; and
a cover adapted to seal over said fuel fill point.

2. The motor vehicle auxiliary fuel tank of claim 1, wherein said main body has shape complementary to the primary fuel tank.

3. The motor vehicle auxiliary fuel tank of claim 2, wherein said main body further comprises overlapping side elements that complement the primary fuel tank.

4. The motor vehicle auxiliary fuel tank of claim 1, wherein said main body further includes fastening means on the exterior surface of said main body.

5. The motor vehicle auxiliary fuel tank of claim 1, including a fuel inlet tube located within said interconnection means.

6. The motor vehicle auxiliary fuel tank of claim 5, wherein said fuel inlet tube includes ear members on said fuel inlet tube.

7. A motorcycle auxiliary fuel tank, including:
a main body;
said main body having a shape complementary to a primary fuel tank and vehicle frame of the motorcycle;
said main body including a reservoir for fuel storage;
a fuel fill point; and
a cover adapted to seal over said fuel fill point.

8. The motorcycle auxiliary fuel tank of claim 7, further including means for interconnecting with the primary fuel tank wherein said interconnecting means provides mechanical support and forms a seal.

9. The motorcycle auxiliary fuel tank of claim 8, said interconnecting means further comprising contour, shape and functionality to directly connect to the primary fuel tank fill point.

10. A method for appending fuel storage capacity on a motor vehicle, said method comprising the steps of:
a) detachably mounting an auxiliary tank to a primary fuel tank of the vehicle, at a fill point of the primary fuel tank to create a single reservoir body;
b) filling the single reservoir body with fuel through an auxiliary fuel tank fill point;
c) allowing fuel to flow from the auxiliary tank within the single reservoir body to the primary fuel tank; and
d) detaching the auxiliary tank from the primary fuel tank.

11. The method of claim 10 further comprising the step of fastening the auxiliary tank to the primary fuel tank, said fastening step being performed before detaching the auxiliary tank from primary fuel tank.

12. The method of claim 11 further comprising the step of sealing the interconnection between the primary fuel tank and the auxiliary tank, said sealing step being performed before detaching the auxiliary fuel tank from primary fuel tank.

13. The method of claim 12, wherein the auxiliary tank mounts on top of the primary fuel tank.

14. The method of claim 10 further comprising the step of venting the auxiliary tank.

15. The method of claim 10 further comprising the steps of:
removing a gas cap from the primary fuel tank before detachably mounting the auxiliary tank to the primary fuel tank; and
replacing the gas cap to the primary fuel tank after detaching the auxiliary tank from the primary fuel tank.
